(19) United States
(12) Patent Application Publication
(10) Pub. No.: US 2009/0058805 A1
(43) Pub. Date: Mar. 5, 2009

(54) Presentation system and method for making a presentation

(76) Inventors: Regina Eunice Groves, Dellwood, MN (US); Thomas Guy Berry, Dellwood, MN (US)

Correspondence Address: Thomas Guy Berry, 36 Spyglass Place, Dellwood, MN, 55110, US

(21) Appl. No.: 12/228,439

(22) Filed: Aug. 13, 2008

Related U.S. Application Data
(60) Provisional application No. 60/966,111, filed on Aug. 25, 2007.

(51) Int. Cl. G06F 3/033; G09G 5/00

(52) U.S. Cl. 345/157; 345/1.1

(57) ABSTRACT

Methods and systems are provided for making a more effective presentation to an audience. A method comprises displaying the presentation on a first display screen oriented for viewing by a presenter while facing the audience while also displaying the presentation on a second display screen (or several display screens) oriented for viewing by the audience. The presenter highlights certain aspects of the presentation by using a laser pointer directed at the first display screen which can be done while the presenter faces the audience and without having to turn away from the audience. An image representing the laser light (and any movement thereof) is displayed at a corresponding relative position on the second display screen (or several display screens) for viewing by the audience in conjunction with the presentation. A presentation system is provided with a laser sensitive presenter screen to detect the laser light which is processed and caused to be displayed to the audience on the presentation screen in conjunction with the presentation.

### CROSS-REFERENCE TO RELATED APPLICATION

This application claims the benefit of U.S. Provisional Application No. 60/966,111 filed Aug. 25, 2007.

### FIELD OF THE INVENTION

The present invention generally relates to presentation equipment and systems and more particularly relates to a system and method for making more effective presentations by allowing the presenter to face the audience during the presentation while highlighting aspects of the presentation.

### BACKGROUND OF THE INVENTION

Contemporary presentations to mid-to-large audiences typically involve a speaker (presenter) standing at a podium and speaking while advancing a slide show such as offered by Power Point or similar presentation applications. Typically, the slide show is projected (or otherwise made visible) on a large presentation screen that the audience can see while the presenter is making audio comments or explanations. More effective presentations involve the presenter leaving the podium and standing on or moving across a stage before the audience. This allows the presenter an opportunity to more effectively engage the audience and deliver a more powerful presentation.

During a presentation, it is common for a presenter to call attention to or highlight certain portions of a slide in the presentation by using a laser pointer (or similar device). Unfortunately, for a presenter at a podium or standing before an audience to use a laser pointer, she must turn her back to the audience so the she can appropriately aim (or direct) the laser pointer to the appropriate portion of the slide. Repeatedly turning her back on an audience to use a laser pointer during a presentation reduces the effectiveness of the presentation as the presenter losses her connection to the audience, which she must attempt to reestablish each time she turns back to face the audience.

From the perspective of the audience, having the presenter repeatedly turn her back to them is both distracting and annoying. Thus, while trying to make a more informative and meaningful presentation, a presenter using a laser pointer during a presentation risks losing her connection with and the attention of the audience that she is trying to educate or inform.

Accordingly, it is desirable to make a more effective presentation that permits highlighting certain aspects of a presentation while facing the audience. In addition, it is desirable to record or capture the presentation as presented with the highlights and audio commentary for contemporaneous or later presentation to another audience. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A system is provided for displaying a presentation on a first display screen oriented for viewing by a presenter while facing the audience while the presentation is also displayed on a second display screen (or several display screens) oriented for viewing by the audience. The system detects the presenter highlighting certain aspects of the presentation using a laser pointer directed at the first display screen, which can be done while the presenter faces the audience and without having to turn away from the audience. A processor causes an image representing the laser light (and any movement thereof) to be displayed at a corresponding relative position on the second display screen (or several display screens) for viewing by the audience in conjunction with the presentation.

A method is provided for displaying a presentation on a first display screen oriented for viewing by a presenter while facing the audience while also displaying the presentation on a second display screen (or several display screens) oriented for viewing by the audience. The presenter highlights certain aspects of the presentation by using a laser pointer directed at the first display screen which can be done while the presenter faces the audience and without having to turn away from the audience. An image representing the laser light (and any movement thereof) is displayed at a corresponding relative position on the second display screen (or several display screens) for viewing by the audience in conjunction with the presentation.

### BRIEF DESCRIPTION OF THE DRAWINGS

The present invention will hereinafter be described in conjunction with the following drawing figures, wherein like numerals denote like elements, and

FIG. 1 is a perspective view of a presentation system in accordance with a preferred embodiment of the present invention;

FIG. 2 is a top view of a presentation system in accordance with a preferred embodiment of the present invention;

FIG. 3 is an illustration of a preferred embodiment of a laser sensitive display for use in the present invention;

FIG. 4 is an illustration of an alternate embodiment of a laser sensitive display for use in the present invention;

FIG. 5 is an illustration of another alternate embodiment of a laser sensitive display for use in the present invention;

FIG. 6 is an illustration exemplifying the laser activated presentation control in accordance with a preferred embodiment of the present invention;

FIG. 7 is an illustration exemplifying the laser activated teleprompter control in accordance with a preferred embodiment of the present invention;

FIG. 8 is a block diagram of the presentation system in accordance with a preferred embodiment of the present invention;

FIG. 9 is chart illustrating detected laser light and corresponding displayed images in accordance with one presentation feature of the present invention; and

FIG. 10 is a flow diagram of a presentation method in accordance with a preferred embodiment of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

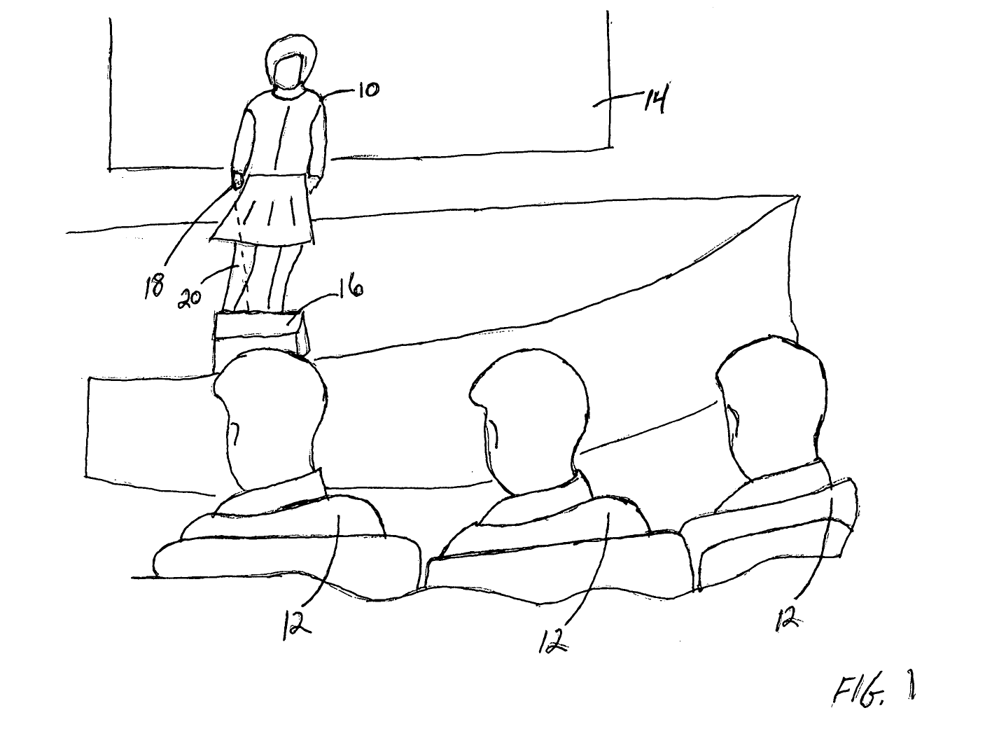

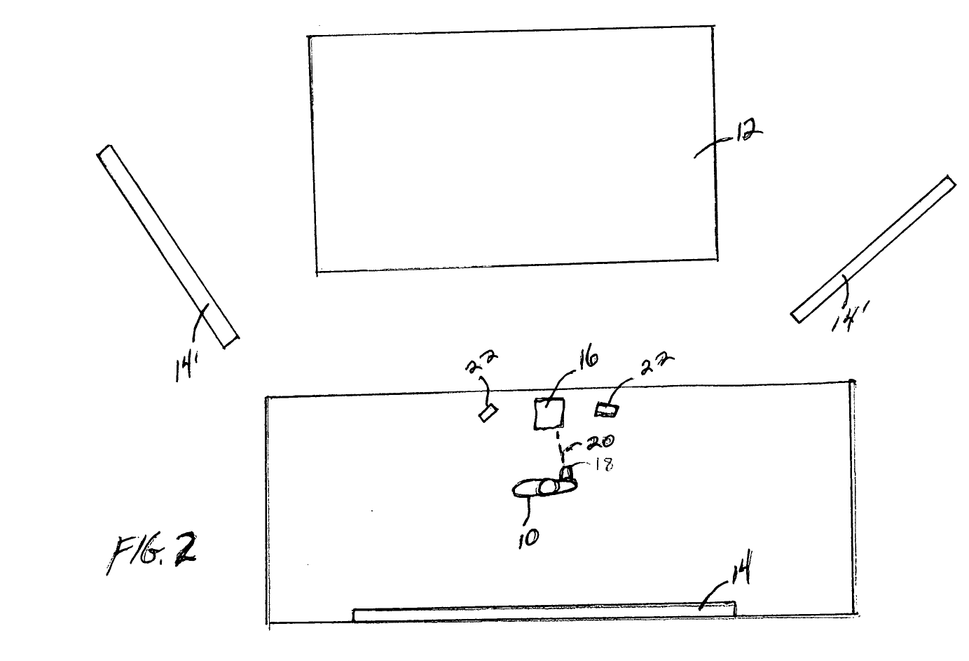

FIGS. 1 and 2 illustrate a presenter 10 giving a presentation to an audience 12. According to the present invention, the presenter 10 is afforded the opportunity to make a more effective presentation by being able to substantially face the audience at all times during the presentation, including when the presenter chooses to highlight certain aspects of the presentation such as by using a laser pointer 18.

As used in the description of the present invention, laser light (or a laser beam) is broadly construed to include any collimated or highly focused energy beam and is not limited light created by the process of lasing a material as understood in physics. The energy beam comprising the “laser” (as used in this specification) can be photons, electrons or other matter capable of being detected when the energy beam is incident on a display or screen. Also, contemporary presentations typically comprise a series of frames or slides such as created by PowerPoint sold by Microsoft Corporation. Each slide can include still images, animation or incorporate video for informing or entertaining the audience 12. As used herein, however, any form of presentation is contemplated for use with the present invention.

According to the present invention, the presenter 10 uses a display or monitor 16 upon which the presenter can observe the current slide being shown to the audience on a presentation screen 14. Depending upon the size of the audience 12 and the acoustics of the auditorium, the presenter may also have a wireless microphone (not shown) so that her voice can be appropriated amplified for the benefit of the audience 12. As can be see in FIGS. 1 and 2, the presenter can highlight certain aspects of the presentation by pointing a laser light (or beam) 20 generated by a laser pointer 18. As will be explained below, the display 16 has a display screen that can detect laser light incident on the display. The position of the detected laser light is sent to a graphics processor or graphics program running on a computer, which causes an image representing the laser light to appear in the same relative position on the presentation screen 14. In this way, the presenter can call attention to certain aspects of the presentation without having to turn away from the audience to direct the laser light to the screen behind her.

Depending on the size of the presentation room or area (e.g., auditorium) the present invention contemplates that the presentation screen has a diagonal size in the range from about four feet to over 150 feet, and can comprise the so called magna-tron displays employed in sports arenas, while the presenter's screen has diagonal size of about nineteen inches to 72 inches. The larger the stage and the more distant the presenter is from the presentation screen generally calls for a larger presenter's screen so that the presenter has a large enough screen to effectively direct the laser light to highlight the displayed presentation slide.

In another embodiment of the present invention, the presentation screen 14 is also a laser sensitive display. In this embodiment, the presenter is afforded an uninterrupted presentation in case she forgets to direct the laser at the presenter's display 16, and out of habit, turns away from the audience to direct the laser toward the presentation display 14. Laser light detected by the presentation display 14 would cause an image to appear on any additional monitors 14′ so that the entire audience can appreciate the highlighting of the presentation.

Since the image representing the laser light incident on the presenter's monitor 16 is generated by a graphics processor or software program, the image appearing on the presentation screen 14 can be made to resemble the laser light or it can be made to be a more contemporary pointer (arrow) shape or any other symbol suitable for the presentation. Also, motion of the laser light (e.g., drawing a circle around some portion of the presentation slide) on the presenter's screen 16 can be graphically processed to be presented to the audience with “smoother” (more controlled) motion so as to highlight the presentation while reducing the possibility of distracting the audience with rapidly moving laser light. Moreover, as discussed below, the present invention contemplates detecting shapes made by the laser light and displaying more uniform graphics representing the laser light and the presentation screen 14 to offer a more effective presentation with a “cleaner” or more polished look.

Referring again to FIG. 2, the presenter is illustrated in a large auditorium presenting to the audience 12. In large audience presentations, it is common for additional presentation screens 14′ to be positioned to afford the audience alternate viewing choices. In this embodiment, the laser light directed by the presenter at the monitor 16 would appear as a corresponding image on each of the presentation screens 14 and 14′. Additionally, for lengthy presentations, it is common for a presenter to use a teleprompter 22 to scroll an outline (or talking points) of the presentation or the full text of a lengthy speech. According to the present invention, the teleprompter screens are also laser sensitive so that the presenter can increase or decrease the speed of the scrolling information, or pause the teleprompter so that the presenter can respond to a question from the audience or discuss a collateral matter momentarily. By affording the presenter 10 the opportunity to highlight and control the presentation without having to turn away from the audience 12 a more effective and informative presentation may be presented to the audience.

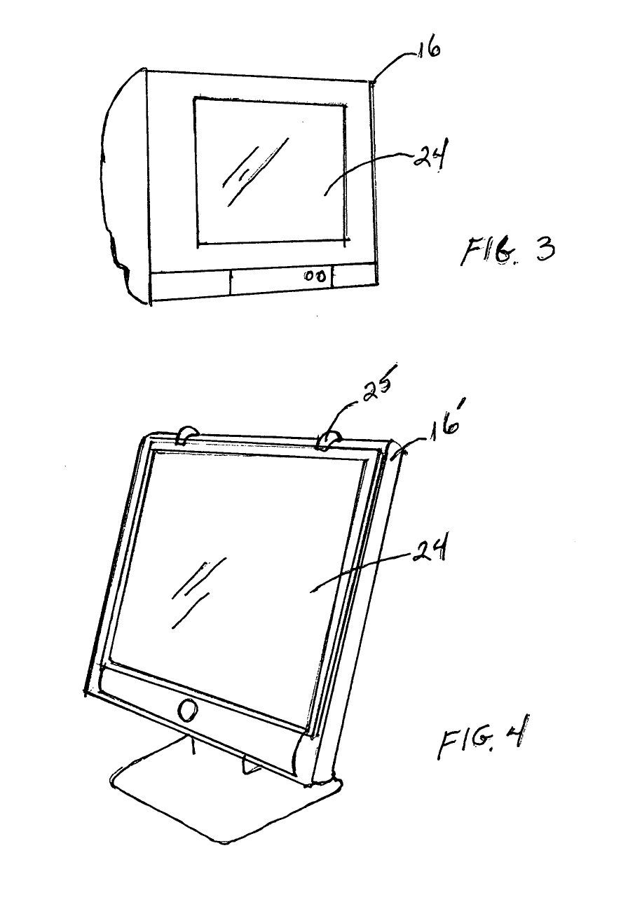

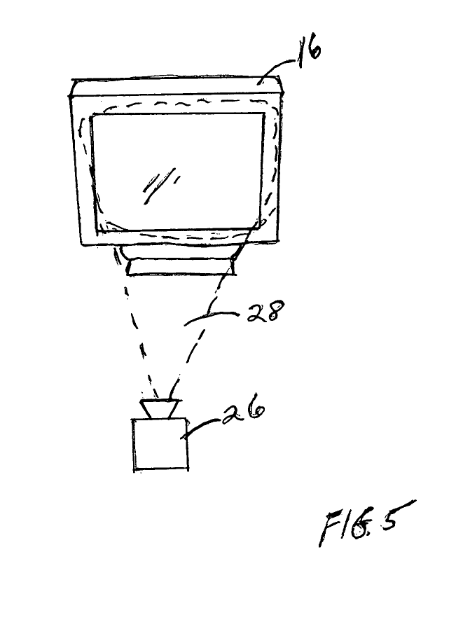

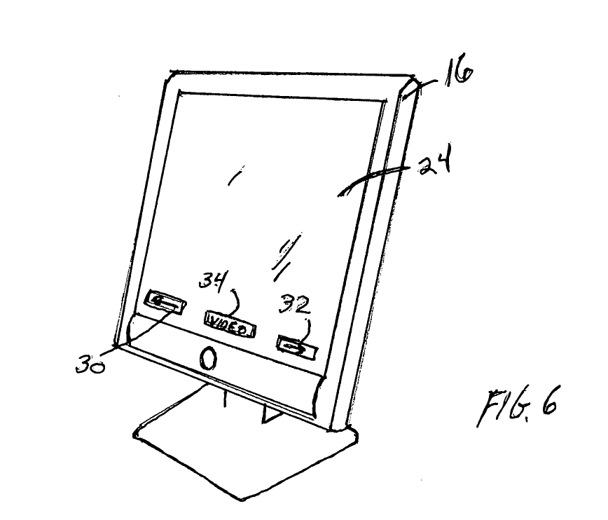

Referring to FIGS. 3-5, the presenter's monitor or display 16 is shown to have a laser sensitive screen 24. In the preferred embodiment of FIG. 3, the laser sensitive screen 24 is integral to the display 16, while FIG. 4 illustrates an alternate embodiment where the laser sensitive screen 24 is positioned over a contemporary display or monitor 16′ via attachments 25. This embodiment is particularly useful to retrofit the present invention into existing presentation systems. Additionally, FIG. 5 illustrates another alternate embodiment where the display of a conventional monitor 16′ is positioned within a field of view 28 of a camera 26. The camera 26 is capable of detecting laser light within the field of view 28, and thus, determine the location of the laser light on the display 16′. This embodiment also facilitates retrofitting the present invention into existing presentation systems, albeit, this embodiment does require space in front of the monitor 16′ to position the camera 26.

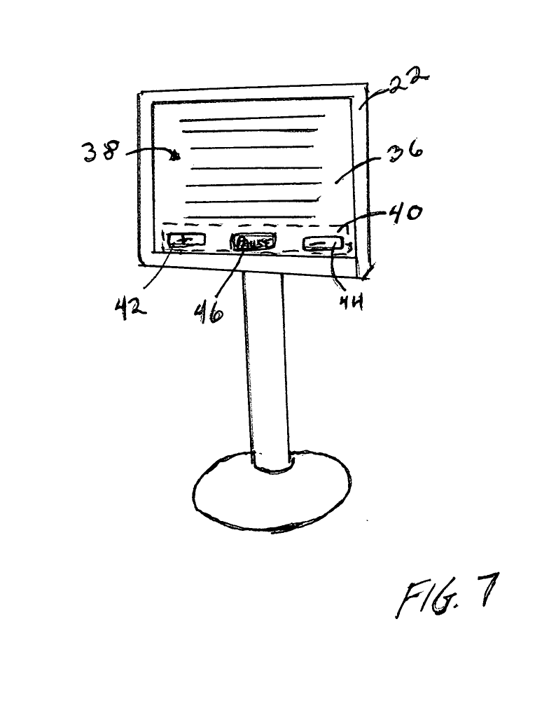

Referring now to FIG. 6, a presenter's monitor or display 16 is shown having laser sensitive display 24 including presentation control areas (30, 32 and 34). According to the present invention, in addition to being able to highlight the presentation without turning away from the audience, the presenter can control the presentation by directing the laser pointer to direct laser light into one or more predetermined areas on the displayed slide. For example, laser light detected in area 30 is associated with a “pervious slide” command. In practice, the area 30 can be labeled “Back”, “Previous”, Previous Slide” or with a symbol such as “<” or “←”. In a similar manner, area 32 can be labeled “Next”, Next Slide” or with a symbol such as “>” or “→”. Finally, other presentation commands can be implemented by laser light detection such as activating some animation, causing a still image to appear, or as shown in FIG. 6, area 34 can bring a video clip into the presentation for viewing by the audience.

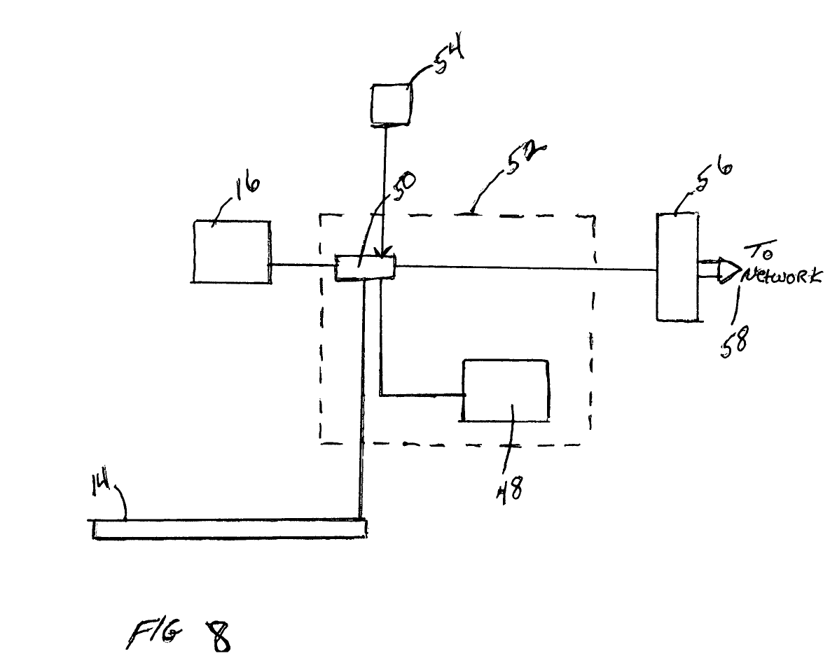

Referring now to FIG. 7, the present invention also contemplates laser control of a teleprompter 22. As with presentation highlighting and presentation slide control, the present invention offers the presenter to apply laser control to a teleprompter by having at least a portion 40 of the teleprompter display 36 be laser sensitive. In this way, the presenter can remain facing the audience and direct laser light to area 42 to, for example, increase the scroll speed of the text 38 displayed by the teleprompter 22. Area 38 can be labeled “Increase”, “Faster” or with a symbol such as “+”. In a similar manner, the scroll speed can be decreased by directing the laser light to area 44, which may be labeled as “Decrease”, “Slower” or “−”. Finally, the present invention contemplates that an area 46 might be used to pause the scrolling of the text 38 in the event, for example, that the presenter takes a question from the audience or decides to discus a collateral topic during the presentation. The many laser control features of the present invention offer the presenter an opportunity to present a more effective presentation by being able to remain substantially facing (e.g., full face or profile, but without having to turn her back to the audience) the audience.

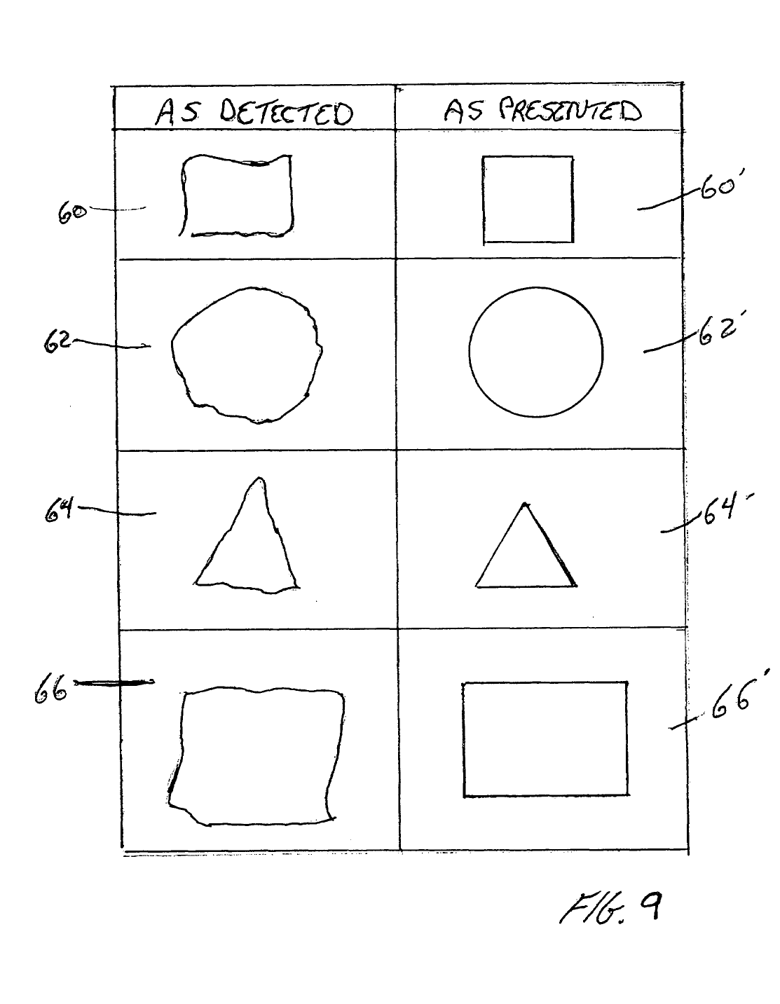

Referring now to FIG. 8, a preferred embodiment of the present invention is shown in block diagram form. The presentation is stored on a computer 48 and data representing the slides to be displayed are sent to a graphics processor 50. Alternately, the computer 48 could be coupled to the presentation display 14 and the presenter's monitor 16, however, by centralizing video, audio and laser detection data in the graphics processor, a synchronized recording or file can be made of the presentation for transmission via a network or burned onto a DVD. Moreover, the graphic processing function can be achieved in the present invention via a software program running on the computer 48, such that, the computer 48 and the graphics processor 50 can be a combined piece of equipment 52. It is also within the scope of the present invention that the processor and operational software be entirely integrated into one unit for the entire presentation system. In such an embodiment, the presenter would need only to bring her presentation slides on a memory key or other memory device that could interface to the presentation through some standard interface (e.g., a USB port). Also, it is within the scope of the presentation invention to have the presentation system connected to an email system or to the Internet such that presentations could be emailed or downloaded to the presentation system.

Once a slide is displayed on the presentation screen and the presenter's screen, the monitor 16 detects laser light incident to the display and sends data representing the relative position of the laser light to the graphics processor 50 (or 52). The graphics process causes an image representing the laser light to appear on the presentation screen 14 (and 14′ if used).

Optionally, the present invention contemplates that the slide data and the laser light data be collected in synchronization with any audio commentary from the presenter (by virtue of the audio system 54) and stored on a data sever 56. The data server 56 is also contemplated by the present invention to be coupled to a network (e.g., the Internet) 58. This allows other to view the presentation with commentary and highlighting just as if they had attended the live presentation. Also, the synchronized slide, audio and laser highlighting data could be burned onto a DVD, for example, for distribution to other employees, students or persons interested in the subject matter of the presentation. In this way, distance learning, national sales meetings or other presentation events can take place.

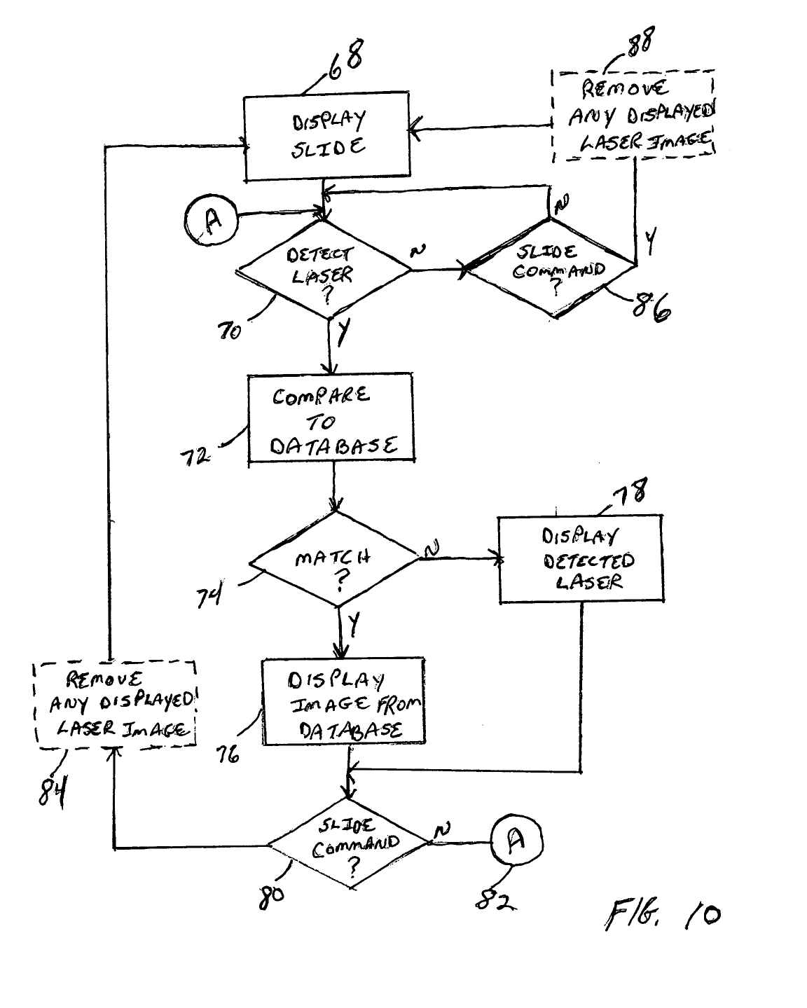

Referring now to FIG. 9, a chart is shown exemplifying how the present invention contemplates presenting an image on the presentation screen 14 to represent the laser light detected by the presenter's screen 16. As mentioned above, in addition to causing an image representing the laser light during the time when it is incident on the presenter's display 16, the present invention contemplates comparing motion of the laser light to a database of images. Upon finding a match (based upon any contemporary comparison criteria) the present invention caused the database image to be display at a corresponding relative position on the presentation screen. As will be understood by those skilled in the art, the line width, line color, persistence or other display variables can be modified by the graphics processor (50 or 52 in FIG. 8).

As seen in box 60, the presenter has used a laser point to roughly define a square on some portion of the display 16. The graphics processor compares the laser potion data to a presentation image data base and locates a match 60′, which would be displayed to the audience at the relative position on the presentation screen 14. In this way, a “cleaner”, more refined presentation can be made for a more effective presentation. In a similar manner, a laser drawn circle 62 is displayed as 62′, a laser drawn triangle 64 is displayed as the triangle 64′ and a laser drawn rectangle is displayed as rectangle 66′.

In one embodiment of the present invention, the images representing the laser light detected on the display 16 persists until the next slide is displayed. Alternately, the images representing the laser light persists until the laser beam is detected on some other area of the display while presenting the same slide. In this way, the presenter can highlight multiple areas of the slide without having multiple highlighted areas of the slide. Alternately, the images representing the laser light detected on the display 16 can be made to persist for a predetermined period of time (e.g., five seconds) or until the presenter directs the laser light to a presentation command area (see FIG. 6) for a “Clear” operation to remove all currently displayed highlighting.

In addition to the display persistence of the images representing the laser light detected on the presenter's monitor 16, the graphics processor 50 (or 52) can change the line color for each highlight gesture detected. For example, the presenter may first draw a circle around one area of a presented slide. The graphics process may cause an image of a red circle from a presentation database. Next, the presenter may draw a square shape around another area of the presented slide. The graphics process may then cause a blue square to be shown on the presentation screen 14 in the corresponding relative area. Those skilled in the art will appreciate that these are only representative images and display variables and any number of images and display variables can be used with the present invention.

Referring now to FIG. 10, a method for presentation a presentation according to a preferred embodiment of the present invention is shown as a flow diagram. In step 68, a presentation slide is displayed on the presentation screen 14 and the presenter's screen 16. Decision 70 determines whether laser light has been detected on the presentation screen 16. If so, the detected laser light is optionally compared to a database (see FIG. 9) in step 72 and decision 74 determines whether a match (to any comparison criteria) has been detected. If so, step displays the image corresponding to the detected laser light in a corresponding relative area of the presentation screen 14. If no match is detected, step 78 displays a representation of the detected laser light on the presentation screen 14. In either case, decision 80 determines whether a presentation slide command (see FIG. 6) has been detected. If so, step 84 optionally removes any displayed laser light images from the presentation screen before displaying a new (previous or next) presentation slide. If step 84 determines that a presentation slide command has not been detected, the routine process to reference letter “A” and decision 70 again tests for detected laser light. In this event, the displayed image from step 76 or step 78 may persist on the presentation display for a predetermined time period, until the laser is detected (step 70) on some other portion of the same presentation slide or until a presentation slide command (decision 80) is detected.

Returning now to decision 70, in the event that laser light is not detected on the currently presented slide, the routine next checks for a slide command (decision 86). If no slide command had been detected, the routine “loops” back to decision 70 until either some laser highlight is made by the presenter or a slide command is detected. In this way, the present invention affords a presenter with an opportunity to make a more effective and informative presentation by being able to remain focused on (substantially facing) the audience and not have turn away from the audience, and particularly, not turn her back on the audience.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A system for making a presentation to an audience, comprising:
a first display having a first display screen oriented for viewing a presentation by a presenter while facing the audience, the first display capable of detecting laser light projected onto the first display screen and providing data representing a relative position of the laser light on the first display screen;
a second display having a second display screen oriented for viewing the presentation by the audience; and
a processor for processing the data representing the relative position of the laser light on the first display screen and causing an image to appear at a corresponding relative position on the second display screen;
wherein, the presenter can highlight aspects of the presentation with a laser pointer for viewing by the audience on the second display screen while facing the audience.

2. The presentation system of claim 1, wherein the first display screen capable of detecting laser light is constructed integrally to the first display.

3. The presentation system of claim 1, wherein the first display screen capable of detecting laser light comprises a substantially transparent laser sensitive screen overlaying a conventional display integral to the first display.

4. The presentation system of claim 1, wherein the first display screen capable of detecting laser light comprises a conventional display integral to the first display in combination with at least one camera focused on the conventional display and capable of detecting laser light within a field of view of the camera.

5. The presentation system of claim 1, further comprising at least a third display having a third display screen oriented for viewing the presentation by the audience and the processor processes the data representing the relative position of the laser light on the first display screen to cause an image to appear at a corresponding relative position on the second display screen and the third display screen.

6. The presentation system of claim 1, further comprising a communication network for communicating the presentation to a fourth display having a fourth display screen oriented for viewing the presentation by a second audience and the processor processes the data representing the relative position of the laser light on the first display screen to cause an image to appear at a corresponding relative position on the forth display screen.

7. The presentation system of claim 6, wherein the second display screen is capable of detecting laser light projected on the second display screen and the processor processes the data representing the relative position of the laser light on the first display screen or the second display screen to cause an image to appear at a corresponding relative position on the forth display screen.

8. The presentation system of claim 1, wherein the second display screen is capable of detecting laser light projected on the second display screen and the processor processes the data representing the relative position of the laser light on the first display screen or the second display screen to cause an image to appear at a corresponding relative position on the third display screen.

9. The presentation system of claim 1, further comprising a microphone and audio system for amplifying audible sounds received by the microphone during the presentation for the audience.

10. The presentation system of claim 9, further comprising a data storage system for storing the presentation, the audible sounds received by the microphone during the presentation and the data representing the relative position of the laser light on the first display.

11. The presentation system of claim 10, further comprising a playback system for subsequent reproduction in a synchronous manner of the presentation, the audible sounds received by the microphone during the presentation and the data representing the relative position of the laser light on the first display thereby facilitating another audience viewing the presentation as originally presented.

12. The presentation system of claim 1, wherein the data representing a relative position of the laser light on the first display screen includes tracking movement of the laser light on the first display screen and the processor processing the data representing the relative position and movement of the laser light on the first display screen causes an image to appear at a corresponding relative position and with corresponding relative movement on the second display screen.

13. The presentation system of claim 12, further comprising an image database within the processor for comparing the data representing the relative position and movement of the laser light to the image database and, upon detecting a sufficient correspondence to a particular image in the image database, for causing an image representing the particular image to appear on the second display screen.

14. The presentation system of claim 13, wherein the particular image persists on the first and second display screen for a predetermined period of time.

15. The presentation system of claim 13, wherein the particular image persists on the first and second display screen until the laser light is detected on another portion of the first display screen.

16. The presentation system of claim 1, wherein the presentation further comprises a plurality of slides viewed on the first and second display screen, at least some of plurality of slides having regions thereof identified for controlling aspects of the presentation when the laser light is detected on the first display screen within the regions.

17. The presentation system of claim 16, wherein the regions identified for controlling aspects of the presentation include at least some of the group of next slide, previous slide, end presentation and play video.

18. The presentation system of claim 1, further comprising a teleprompter system having a teleprompter screen for presenting text associated with the presentation to the presenter.

19. The presentation system of claim 18, wherein at least of portion of the teleprompter screen is capable of detecting the laser light over regions thereof associated with controlling aspects of the teleprompter system.

20. The presentation system of claim 19, where the aspects of the teleprompter system controlled by the laser light being detected over the regions comprise at least one of the group of increase speed, reduce speed, pause and resume.

21. A method for making a presentation to an audience, comprising:
displaying the presentation on a first display screen oriented for viewing by a presenter while facing the audience;
displaying the presentation on a second display screen oriented for viewing by the audience;
detecting laser light projected onto the first display screen by the presenter facing the audience; and
displaying an image representing the laser light at a corresponding relative position on the second display screen for viewing by the audience in conjunction with the presentation.

22. A system enabling a presenter to highlight aspects of a presentation to an audience without having to turn away from the audience, comprising:
a presentation screen oriented for viewing by the audience;
a presenter screen, smaller in size than the large presentation screen, oriented for viewing by the presenter while facing the audience, the presenter screen capable of detecting laser light projected thereon and providing data representing a relative position of the laser light on the presenter screen; and
a processor for processing the data representing the relative position of the laser light on the presenter screen and causing an image to appear for the audience at a corresponding relative position on the large presentation screen.

23. The system of claim 22, wherein the presentation screen has a diagonal size in a range from four feet to 150 feet.

24. The system of claim 22, wherein the presenter screen has a diagonal size in a range from nineteen inches to 72 inches.
